(19) United States
(12) Patent Application Publication
(10) Pub. No.: US 2008/0240721 A1
(43) Pub. Date: Oct. 2, 2008

(54) OPTICAL RECEIVER, RECEPTION CONTROL METHOD AND RECEPTION CONTROL PROGRAM

(76) Inventor: MORIHIKO OTA, Tokyo (JP)

Correspondence Address: NEC CORPORATION OF AMERICA, 6535 N. STATE HWY 161, IRVING, TX, 75039, US

(21) Appl. No.: 12/054,803

(22) Filed: Mar. 25, 2008

(30) Foreign Application Priority Data
Mar. 26, 2007 (JP) 78228/2007
Feb. 22, 2008 (JP) 41350/2008

(51) Int. Cl. H04B 10/00

(52) U.S. Cl. 398/115

(57) ABSTRACT

An exemplary aspect of the present invention is an optical receiver which is used in an optical transmission system, and which receives an optical signal and converts the optical signal into an electrical signal, the optical receiver comprising a controller, and a delay interferometer, wherein the controller sends, to the delay interferometer, delay information corresponding to a modulation scheme with which the optical signal is modulated, the modulation scheme being any one of an intensity modulation scheme and a phase modulation scheme and the delay interferometer separates the optical signal and causes a delay in one of the separated signals by use of the delay information, thereafter causes an interference between the separated signals, and thereby outputs two optical signals including different interference levels.

This application is based upon and claims the benefit of priority from Japanese Patent Application No. 2007-078228 filed on Mar. 26, 2007 and Japanese Patent Application No. 2008-041350 filed Feb. 22, 2008, the contents of which are incorporated by reference.

### BACKGROUND ART

1. Field of the Invention

The present invention relates to an optical receiver which is used in an optical transmission system, and which receives an optical signal and converts the received optical signal into an electrical signal. The invention also relates to a reception control method and a reception control program for the optical receiver.

2. Description of the Related Art

For example, as disclosed in Japanese Patent Laid-open Application Publication No. Hei9-147283, various modulation schemes such as intensity modulation and phase modulation are employed in a long-haul transmission system in which the transmission rate is not less than 40 Gbps. Since each modulation scheme has its advantage and disadvantage, a most appropriate scheme is used according to the purpose of the system. FIG. 4 shows a configuration of a receiver used in the phase modulation scheme of the related art. In FIG. 4, a delay interferometer 202 receives an optical signal 201 modulated by differential phase-shift keying, separates the received optical signal 201 into two signals, and causes a delay in one of the signals so that the separated signals interfere with each other. As a result, the delay interferometer 202 outputs two optical signals, a C (constructive interference) component and a D (destructive interference) component. A balanced receiver 203 receives the two optical signals, the C component and the D component, outputted from the delay interferometer 202 and performs optical to electrical (OE) conversion thereon. Thus, the balanced receiver 203 outputs the difference of the signals generated by the conversion. Meanwhile, FIG. 5 shows a configuration of a receiver used in the intensity modulation scheme which is also a related art. In FIG. 5, a receiver 302 receives an optical signal 301 modulated with intensity modulation, performs OE conversion thereon and outputs the resultant signal.

However, in the long-haul transmission system of the related arts, the configuration of a receiver varies depending on whether the employed scheme is intensity modulation or phase modulation, as can be seen from FIGS. 4 and 5. For this reason, a problem arises that a different receiver is required for each of the schemes.

### SUMMARY

An exemplary object of the present invention is to provide a receiver adaptable to both of the intensity modulation scheme and the phase modulation scheme, to be used in a long-haul transmission system.

An exemplary aspect of the present invention is an optical receiver which is used in an optical transmission system, and which receives an optical signal and converts the optical signal into an electrical signal, the optical receiver comprising a controller, and a delay interferometer, wherein the controller sends, to the delay interferometer, delay information corresponding to a modulation scheme with which the optical signal is modulated, the modulation scheme being any one of an intensity modulation scheme and a phase modulation scheme and the delay interferometer separates the optical signal and causes a delay in one of the separated signals by use of the delay information, thereafter causes an interference between the separated signals, and thereby outputs two optical signals including different interference levels.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram showing a configuration of an optical receiver used in an optical transmission system of a first and a second exemplary embodiment;

FIG. 2 is a block diagram showing an exemplary hardware configuration of an optical receiver 100 used in the optical transmission system of the first exemplary embodiment;

FIG. 3 is a flowchart illustrating an operation of the optical receiver of a second exemplary embodiment;

FIG. 4 is a block diagram showing a configuration of a receiver used in the phase modulation scheme of the related art;

FIG. 5 is a block diagram showing a configuration of a receiver used in the intensity modulation scheme of the related art; and

FIG. 6 is a flowchart illustrating an operation of an optical receiver of the first exemplary embodiment.

### DETAILED DESCRIPTION OF THE PREFERRED EMBODIMENTS

### 1. First Exemplary Embodiment

Hereinafter, a detailed description will be given for a first exemplary embodiment of the present invention with reference to the drawings.

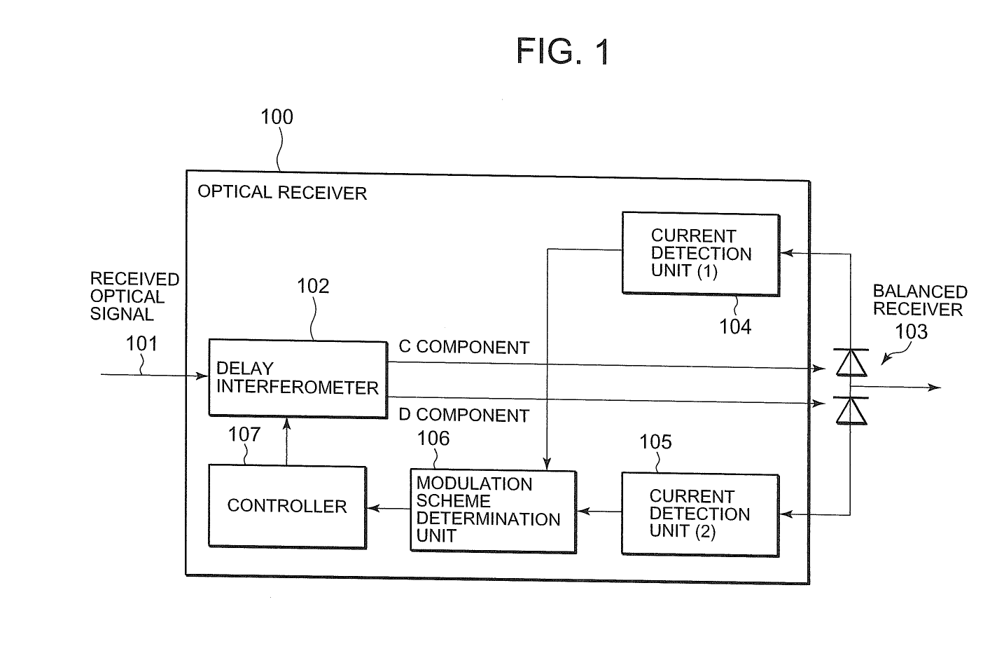

FIG. 1 is a block diagram showing a configuration of an optical receiver of an optical transmission system of the first exemplary embodiment.

As shown in FIG. 1, an optical receiver 100 of the first exemplary embodiment includes a delay interferometer 102, a balanced receiver 103, a current detection unit (1) 104, a current detection unit (2) 105, a modulation scheme determination unit 106, and a controller 107.

The delay interferometer 102 has a function of separating a received optical signal 101 into two paths, and causing the signals to interfere with each other by causing a certain amount of delay in the phase of one of the separated optical signals. Here, the certain amount of the delay is set by the controller 107. Consequently, the delay interferometer 102 outputs two signals, a C (constructive interference) component and a D (destructive interference) component.

Incidentally, the C component is a component formed by constructive interference. In the C component, two (or more) waves including the same frequency are in phase, enforcing each other to eventually form a wave the amplitude of which is the total of the oscillation of each of the waves.

Meanwhile, the D component is a component formed by destructive interference. In the D component, waves including the same frequencies are 180° out of phase, so that a crest of one wave coincides with a trough of another, thereby canceling out the oscillation of the waves.

The balanced receiver 103 has a function of receiving the two signals, C and D components, outputted from the delay interferometer 102 and then performing optical to electrical (OE) conversion thereon. Thus, the balanced receiver 103 outputs a differential signal of the signals generated by the conversion.

The current detection unit (1) 104 has a function of detecting a current of the C component and thereby outputting a detected current I1. The C component here is obtained from the optical to electrical (OE) conversion carried out by the balanced receiver 103. Similarly, The current detection unit (2) 105 has a function of detecting a current of the D component and thereby outputting a detected current I2. The D component here is also obtained from the optical to electrical (OE) conversion carried out by the balanced receiver 103.

The modulation scheme determination unit 106 has a function of determining the appropriate modulation scheme for the signal inputted to the optical receiver 100, on the basis of the detected currents II and I2 respectively outputted from the current detection units (1) 104 and (2) 105.

The controller 107 has a function of setting a delay amount in the delay interferometer 102. The delay amount is set in accordance with the modulation scheme determined by the modulation scheme determination unit 106.

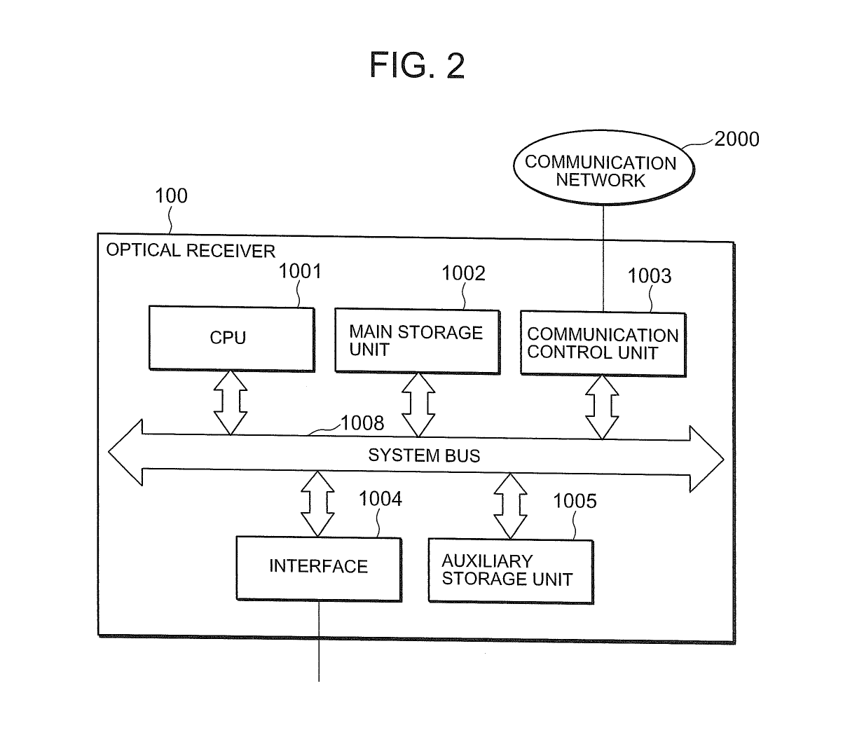

An exemplary hardware configuration of the optical receiver 100 is shown in FIG. 2.

As shown in FIG. 2, the optical receiver 100 of the present invention can be implemented by employing the same hardware configuration as that of a general computer. The optical receiver 100 includes a CPU (Central Processing Unit) 1001, a main storage unit 1002, a communication control unit 1003, an interface 1004, an auxiliary storage unit 1005, a system bus 1006, and the like. To be specific, the main storage unit 1002 is a main memory such as a RAM (Random Access Memory), and is used as a work area or a buffer for data. The communication control unit 1003 transmits and receives data through a communication network 2000. The interface 1004 is provided to connect to peripheral devices for transmission and reception of data. The auxiliary storage unit 1005 is a hard disk device configured of a nonvolatile memory such as a ROM (Read Only Memory), a magnetic disk, and a semiconductor memory. The system bus 1006 is provided to mutually connect each of the above-mentioned components of the information processor.

The operation of the optical receiver 100 of the present invention can be implemented by hardware, by packaging a circuit component in the optical receiver 100. Here, the circuit component is configured of a hardware component such as an LSI (Large Scale Integration) which includes a program for implementing the above functions of the optical receiver 100. Otherwise, the operation of the optical receiver 100 can be implemented by software, by causing the CPU 1001 of the computer to execute a program which provides the functions of the above components.

To be precise, the CPU 1001 controls the operation of the optical receiver 100 by loading a program stored in the auxiliary storage device 1005 onto the main storage unit 1002 and executing the program. Hence, the CPU 1001 implements the above-mentioned functions by software.

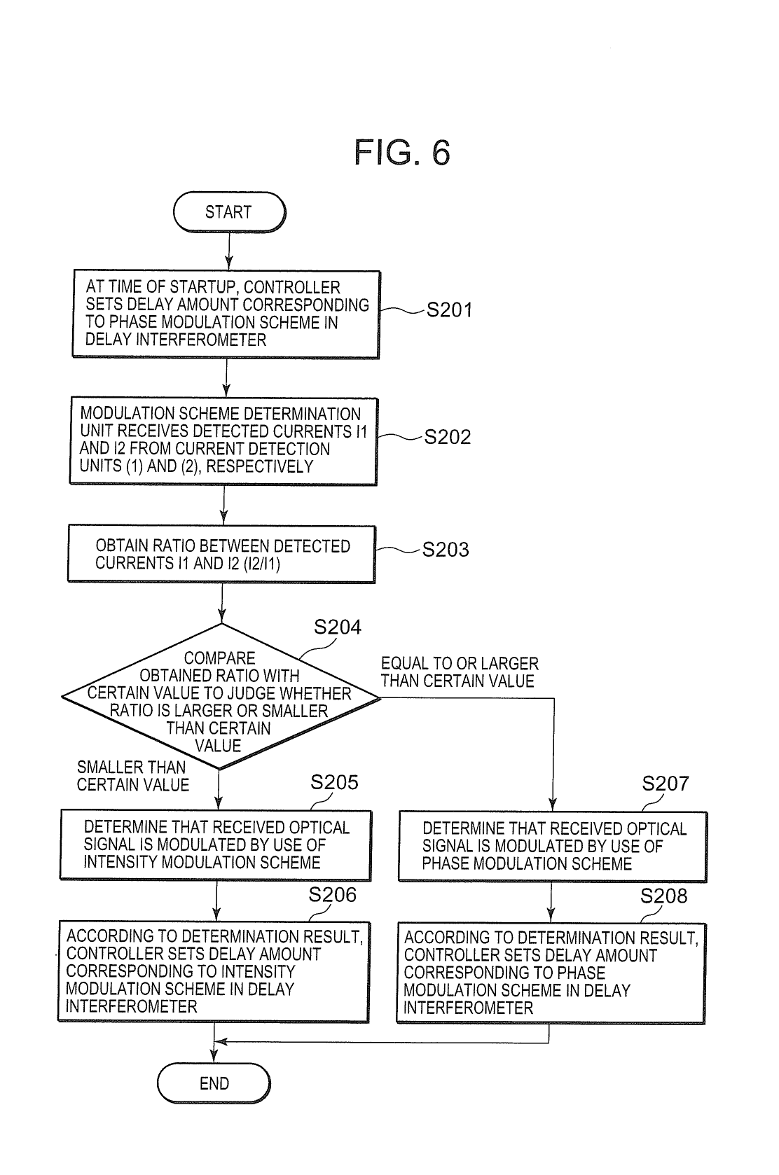

FIG. 6 is a flowchart showing an operation of the optical receiver of the first exemplary embodiment.

As shown in FIG. 6, firstly at the startup time of the optical receiver 100, the controller 107 sets a delay amount corresponding to the phase modulation scheme in the delay interferometer 102 (S201).

Subsequently, the optical receiver 100 receives the first optical signal 101. Upon reception of the detected currents I1 and I2 respectively from the current detection units (1) 104 and (2) 105 (S202), the modulation scheme determination unit 106 obtains a ratio between the detected currents I1 and I2 (I2/I1) (S203). Then, the modulation scheme determination unit 106 compares the obtained ratio with a certain value (such as 1/2) to judge whether the ratio is larger, equal to or smaller than the certain value (S204).

At this time, if the ratio is smaller than the certain value, for example, the modulation scheme determination unit 106 determines that the received optical signal 101 is modulated by use of the intensity modulation scheme (S205). Then, the controller 107 sets a delay amount corresponding to the intensity modulation scheme in the delay interferometer 102, according to the determination result of the modulation scheme determination unit 106 (S206).

On setting the delay amount corresponding to the intensity modulation scheme in the delay interferometer 102, the optical receiver 100 may hereafter operate as a dedicated optical receiver 100 for the intensity modulation scheme.

On the other hand, if the ratio is equal to or larger than the certain value, for example, the modulation scheme determination unit 106 determines that the received optical signal 101 is modulated by use of the phase modulation scheme (S207). Then, the controller 107 sets a delay amount corresponding to the phase modulation scheme in the delay interferometer 102, according to the determination result of the modulation scheme determination unit 106 (S208).

On setting the delay amount corresponding to the phase modulation scheme in the delay interferometer 102, the optical receiver 100 may hereafter operate as a dedicated optical receiver 100 for the phase modulation scheme.

Generally, in a case where the received optical signal 101 is modulated by use of the phase modulation scheme, a signal including a certain level of D component is outputted from the delay interferometer 102. However, in a case where the received optical signal 101 is modulated by use of the intensity modulation scheme, only the C component formed by constructive interference is outputted, and the D component formed by destructive interference is hardly outputted. This is because, in the case of the intensity modulation scheme, the phase of the received optical signal 101 is not inverted (no change occurs in the phase), even when a delay of the delay amount corresponding to the phase modulation scheme is caused in one of the phases into which the received optical signal 101 is separated.

In this regard, in the first exemplary embodiment, a ratio between signals of a C component and of a D component outputted when the received optical signal 101 is modulated by use of the phase modulation scheme (D/C) (such as 1/2), is set as the above-mentioned certain value. Then, the ratio is used to determine the modulation scheme of the received optical signal 101 in the following way. In a case where a ratio between the detected current I1 of the C component signal and the detected current I2 of the D component signal (I2/I1) is equal to or larger than the certain value, a determination can be made that the received optical signal 101 is modulated by use of the phase modulation scheme. On the other hand, in a case where the ratio (I2/I1) is smaller than the certain value, a determination can be made that the received optical signal 101 is modulated by use of the intensity modulation scheme.

By use of the present invention, an appropriate modulation scheme can be selected between the intensity modulation scheme and the phase modulation scheme, and be set in the delay interferometer 102.

This is made possible with the following operation. Upon receipt of the detected currents I1 and I2 respectively from the current detection units (1) 104 and (2) 105, the modulation scheme determination unit 106 obtains a ratio between the detected currents I1 and I2 (I2/I1), and determines the modulation scheme of the received optical signal 101 according to whether the obtained ratio is larger, equal to or smaller than a certain value (such as 1/2). Then, the controller 107 sets, in the delay interferometer 102, an appropriate delay amount corresponding to the modulation scheme determined by the modulation scheme determination unit 106.

### 2. Second Exemplary Embodiment

Hereinafter, a detailed description will be given for a second exemplary embodiment of the present invention with reference to the drawings.

FIG. 1 is a block diagram showing a configuration of an optical receiver of an optical transmission system of the second exemplary embodiment.

As shown in FIG. 1, an optical receiver 100 of the second exemplary embodiment includes a delay interferometer 102, a balanced receiver 103, a current detection unit (1) 104, a current detection unit (2) 105, a modulation scheme determination unit 106, and a controller 107.

The delay interferometer 102 has a function of separating a received optical signal 101 into two paths, and causing the signals to interfere with each other by causing a certain amount of delay in the phase of one of the separated optical signals. Consequently, the delay interferometer 102 outputs two signals, a C (constructive interference) component and a D (destructive interference) component.

Incidentally, the C component is a component formed by constructive interference. In the C component, two (or more) waves including the same frequency are in phase, enforcing each other to eventually form a wave the amplitude of which is the total of the oscillations of the waves.

Meanwhile, the D component is a component formed by destructive interference. In the D component, waves including the same frequencies are 180° out of phase, so that a crest of one wave coincides with a trough of another, thereby canceling out the oscillation.

The balanced receiver 103 has a function of receiving the two signals, C and D components, outputted from the delay interferometer 102 and then performing optical to electrical (OE) conversion thereon. Thus, the balanced receiver 103 outputs a differential signal of the signals generated by the conversion.

The current detection unit (1) 104 has a function of detecting a current of the balanced receiver 103 and thereby outputting a detected current I1. Similarly, The current detection unit (2) 105 has a function of detecting a current of the balanced receiver 103 and thereby outputting a detected current I2.

The modulation scheme determination unit 106 has a function of determining the appropriate modulation scheme for the signal inputted to the optical receiver 100, on the basis of the detected currents I1 and I2 respectively outputted from the current detection units (1) 104 and (2) 105.

The controller 107 has a function of setting a delay amount in the delay interferometer 102. The delay amount is set in accordance with the modulation scheme determined by the modulation scheme determination unit 106.

An exemplary hardware configuration of the optical receiver 100 is shown in FIG. 2.

As shown in FIG. 2, the optical receiver 100 of the present invention can be implemented by employing the same hardware configuration as that of a general computer. The optical receiver 100 includes a CPU (Central Processing Unit) 1001, a main storage unit 1002, a communication control unit 1003, an interface 1004, an auxiliary storage unit 1005, a system bus 1006, and the like. To be specific, the main storage unit 1002 is a main memory such as a RAM (Random Access Memory), and is used as a work area or a buffer for data. The communication control unit 1003 transmits and receives data through a communication network 2000. The interface 1004 is provided to connect to peripheral devices for transmission and reception of data. The auxiliary storage unit 1005 is a hard disk device configured of a nonvolatile memory such as a ROM (Read Only Memory), a magnetic disk, and a semiconductor memory. The system bus 1006 is provided to mutually connect each of the above-mentioned components of the information processor.

The operation of the optical receiver 100 of the present invention can be implemented by hardware, by packaging a circuit component in the optical receiver 100. Here, the circuit component is configured of a hardware component such as an LSI (Large Scale Integration) which includes a program for implementing the above functions of the optical receiver 100. Otherwise, the operation of the optical receiver 100 can be implemented by software, by causing the CPU 1001 of the computer to execute a program which provides the functions of the above components.

To be precise, the CPU 1001 controls the operation of the optical receiver 100 by loading a program stored in the auxiliary storage device 1005 onto the main storage unit 1002 and executing the program. Hence, the CPU 1001 implements the above-mentioned functions by software.

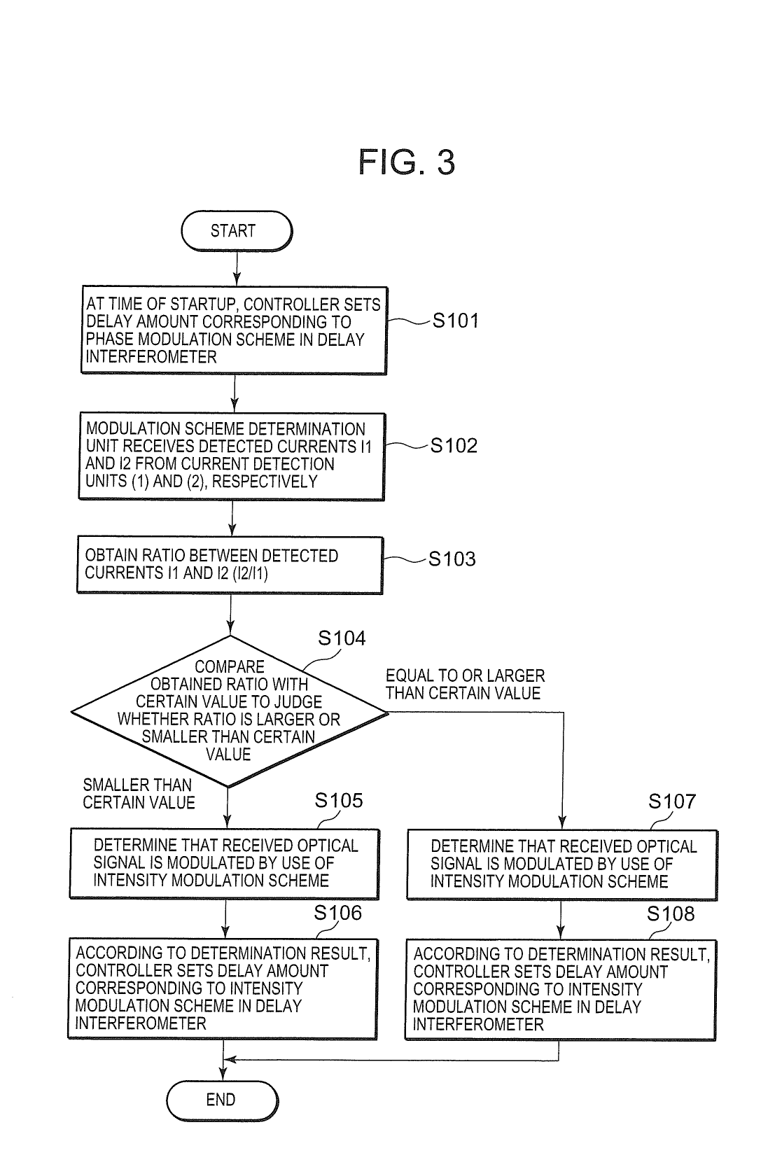

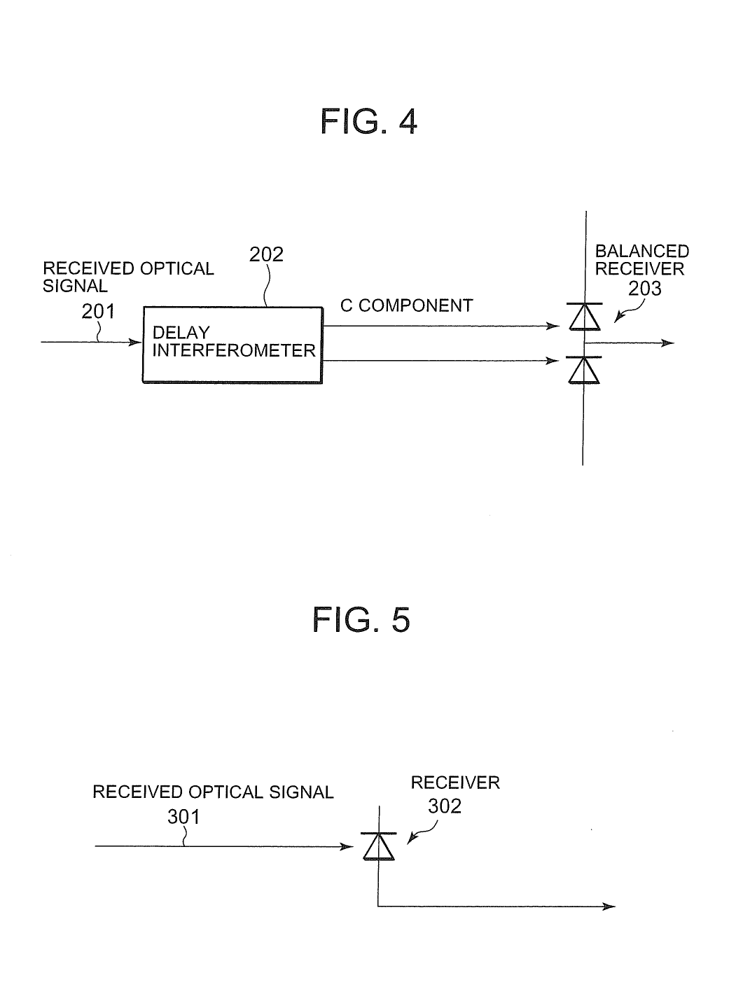

FIG. 3 is a flowchart showing an operation of the optical receiver of the second exemplary embodiment.

As shown in FIG. 3, firstly at the startup time of the optical receiver 100, the controller 107 sets a delay amount corresponding to the phase modulation scheme in the delay interferometer 102 (S101).

Subsequently, upon reception of the detected currents I1 and I2 respectively from the current detection units (1) 104 and (2) 105 (S102), the modulation scheme determination unit 106 obtains a ratio between the detected currents I1 and I2 (I2/I1) (S103). Then, the modulation scheme determination unit 106 compares the obtained ratio with a certain value (such as 1/2) to judge whether the ratio is larger, equal to or smaller than the value (S104).

At this time, if the ratio is smaller than the certain value, for example, the modulation scheme determination unit 106 determines that the received optical signal 101 is modulated by use of the intensity modulation scheme (S105). Then, the controller 107 sets a delay amount corresponding to the intensity modulation scheme in the delay interferometer 102, according to the determination result of the modulation scheme determination unit 106 (S106).

On the other hand, if the ratio is equal to or larger than the certain value, for example, the modulation scheme determination unit 106 determines that the received optical signal 101 is modulated by use of the phase modulation scheme (S107). Then, the controller 107 sets a delay amount corresponding to the phase modulation scheme in the delay interferometer 102, according to the determination result of the modulation scheme determination unit 106 (S108).

By use of the present invention, an appropriate modulation scheme can be selected between the intensity modulation scheme and the phase modulation scheme, and be set in the delay interferometer 102.

This is made possible with the following operation. Upon receipt of the detected currents II and I2 respectively from the current detection units (1) 104 and (2) 105, the modulation scheme determination unit 106 obtains a ratio between the detected currents I1 and I2 (I2/I1), and determines the modulation scheme of the received optical signal 101 according to whether the obtained ratio is larger, equal to or smaller than a certain value (such as 1/2). Then, the controller 107 sets, in the delay interferometer 102, an appropriate delay amount corresponding to the modulation scheme determined by the modulation scheme determination unit 106.

### 3. Third Exemplary Embodiment

The aforementioned object is achieved by an optical receiver of the present invention which is used in an optical transmission system, and which receives an optical signal and converts the optical signal into an electrical signal. The optical receiver is characterized by including a delay interferometer and a controller. Specifically, the delay interferometer separates the received optical signal, causes the separated signals to interfere with each other by causing a delay in one of the signals, and thereby outputs two optical signals each including a different interference level. The controller sets, in the delay interferometer, a delay amount of a value corresponding to either an optical signal modulated by the intensity modulation scheme or an optical signal modulated by the phase modulation scheme.

### (Effect)

With the above configuration, a delay amount of a value corresponding to either an optical signal modulated by the intensity modulation scheme or an optical signal modulated by the phase modulation scheme can be set in the delay interferometer.

According to the present invention, the delay amount of the delay interferometer is set to an appropriate value in accordance with the modulation scheme of an inputted optical signal. Thus, the optical receiver of the present invention is adaptable to both of the intensity modulation scheme and the phase modulation scheme.

The previous description of these embodiments is provided to enable a person skilled in the art to make and use the present invention. Moreover, various modifications to the embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

What is claimed is:

1. An optical receiver which is used in an optical transmission system, and which receives an optical signal and converts the optical signal into an electrical signal, the optical receiver comprising
a controller, and
a delay interferometer, wherein:
the controller sends, to the delay interferometer, delay information corresponding to a modulation scheme with which the optical signal is modulated, the modulation scheme being any one of an intensity modulation scheme and a phase modulation scheme; and
the delay interferometer separates the optical signal and causes a delay in one of the separated signals by use of the delay information, thereafter causes an interference between the separated signals, and thereby outputs two optical signals including different interference levels.

2. The optical receiver according to claim 1 further comprising
a determination unit, wherein:
the determination unit determines the modulation scheme of the received optical signal on the basis of the signals generated by electrically converting the two optical signals including different interference levels; and
the controller sends, to the delay interferometer, the delay information corresponding to the modulation scheme, which is determined by the determination unit.

3. The optical receiver according to claim 2 further comprising
a balanced receiver, and
a current detection unit, wherein:
the balanced receiver converts, into electrical signals, the two optical signals including different interference levels, which have been outputted from the delay interferometer, and thereby outputs a differential signal of the signals generated by the conversion;
the current detection unit detects a current value of the two optical signals including different interference levels; and
the determination unit determines the modulation scheme appropriate for the received optical signal by comparing, with a certain threshold, a ratio between the current values, which are detected by the current detection unit, of the two optical signals including different interference levels to judge whether the ratio is larger, equal to or smaller than the certain threshold.

4. The optical receiver according to claim 1, wherein
at the time of startup of the optical receiver, the determination unit sends, to the delay interferometer, the delay information corresponding to the phase modulation scheme.

5. The optical receiver according to claim 1, wherein
the two optical signals including different interference levels are a C component formed by constructive interference and a D component formed by destructive interference, respectively.

6. A reception control method for an optical receiver which is used in an optical transmission system, and which receives an optical signal and converts the optical signal into an electrical signal, the method comprising the steps of:
generating delay information corresponding to a modulation scheme with which the optical signal is modulated, the modulation scheme being any one of an intensity modulation scheme and a phase modulation scheme; and
outputting two optical signals including different interference levels by separating the optical signal and causing a delay in one of the signals by use of the delay information, and thereby causing an interference between the separated signals.

7. The reception control method according to claim 6, further comprising the steps of:
determining the modulation scheme of the received optical signal on the basis of the signals generated by electrically converting the two optical signals including different interference levels; and
generating the delay information corresponding to the determined modulation scheme.

8. The reception control method according to claim 7, further comprising the steps of:
converting the two optical signals including different interference levels into electrical signals, and thereby outputting a differential signal of the signals generated by the conversion;
detecting current values of the two optical signals including different interference levels; and
determining the modulation scheme appropriate for the received optical signal by comparing, with a certain threshold, a ratio between the current values, which are detected by the current detection unit, of the two optical signals including different interference levels to judge whether the ratio is larger, equal to or smaller than the certain threshold.

9. The reception control method according to claim 6, wherein
at the time of startup of the optical receiver, two optical signals including different interference levels are outputted by use of delay information corresponding to the phase modulation scheme.

10. The reception control method according to claim 6, wherein
the two optical signals including different interference levels are a C component formed by constructive interference and a D component formed by destructive interference, respectively.

11. An optical receiver which is used in an optical transmission system, and which receives an optical signal and converts the optical signal into an electrical signal, the optical receiver comprising
a control means for sending, to the delay interferometer, delay information corresponding to a modulation scheme with which the optical signal is modulated, the modulation scheme being any one of an intensity modulation scheme and a phase modulation scheme; and
a delay interferometer means for separating the optical signal and causing a delay in one of the separated signals by use of the delay information, thereafter causing an interference between the separated signals, and thereby outputs two optical signals including different interference levels.

12. The optical receiver according to claim 11 further comprising
a determination means for determining the modulation scheme of the received optical signal on the basis of the signals generated by electrically converting the two optical signals including different interference levels; and
the control means for sending, to the delay interferometer, the delay information corresponding to the modulation scheme, which is determined by the determination means.

13. The optical receiver according to claim 12 further comprising
a balanced receiving means for converting, into electrical signals, the two optical signals including different interference levels, which have been outputted from the delay interferometer, and thereby outputting a differential signal of the signals generated by the conversion;
a current detection means for detecting a current value of the two optical signals including different interference levels; and
the determination means for determining the modulation scheme appropriate for the received optical signal by comparing, with a certain threshold, a ratio between the current values, which are detected by the current detection unit, of the two optical signals including different interference levels to judge whether the ratio is larger, equal to or smaller than the certain threshold.
